(19) United States
(12) Patent Application Publication
(10) Pub. No.: US 2010/0270697 A1
(43) Pub. Date: Oct. 28, 2010

(54) Manufacturing method of a mouse pad capable of enhancing precision of detecting displacement of optical mouse

(76) Inventor: Ken-Pei Hu, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/457,470

(22) Filed: Jun. 11, 2009

(30) Foreign Application Priority Data
Apr. 22, 2009 (CN) 200910135073.0

(51) Int. Cl. B29C 43/20

(52) U.S. Cl. 264/48; 264/129

(57) ABSTRACT

A manufacturing method of a mouse pad capable of enhancing the precision of detecting a displacement of an optical mouse includes: mixing silicone and light reflecting particles to form a mixed material; putting the mixed material into a mold to form a pad body by hot pressing; coating a transparent coating onto a surface of the pad body to form a flat smooth layer on the surface to produce a mouse pad. Since the smooth layer is on the surface of the mouse pad, users can smoothly move an optical mouse on the smooth layer. The optical mouse emits a light to the mouse pad to detect a displacement, and each light reflecting particle forms an image with a significant difference on an optical sensor of the optical mouse by a light reflection or refraction to determine the optical mouse moving direction and displacement according to the images.

### FIELD OF THE INVENTION

The present invention generally relates to mouse pads, in particular to a manufacturing method of a mouse pad with a pad body having a plurality of light reflecting particles, such that if a user moves an optical mouse, the optical mouse will emit a light to the mouse pad for detecting a displacement, and an optical sensor of the optical mouse can detect an image having a significant difference to accurately determine the moving direction and displacement of the optical mouse based on a light reflection or refraction of each light reflecting particle.

### BACKGROUND OF THE INVENTION

In an application of a roller mouse, dust and dirt may be stuck onto a roller or entered into the roller mouse easily, and thus a detecting device installed inside the roller mouse for detecting the moving direction and displacement of the roller mouse is interfered by the dust and dirt, and a detecting error may result. Therefore, when a cursor is controlled and displayed on a display screen of a computer device, the cursor cannot be moved smoothly or accurately, thus causing troubles and inconvenience to users.

Based on the aforementioned issues, the roller mouse is eliminated from the market and replaced by an optical mouse in recent years. In FIG. 1, the optical mouse 10 includes a light emitting element 11 and an optical sensor 12. If a user connects the optical mouse 10 to a computer device and places and moves the optical mouse 10 on a mouse pad 13, the optical mouse 10 will emit a light from the light emitting element 11 to a surface of the mouse pad 13 for detecting a displacement of the optical mouse 10. The optical sensor 12 senses an image formed by the light refracted or reflected from the mouse pad 13, so that the optical mouse 10 can determine the moving direction and displacement of the optical mouse 10 according to the image, and transmit a corresponding moving signal to the computer device, so as to allow the user to achieve the effect of using the optical mouse 10 to control and display a cursor on a display screen of the computer device.

Since the optical mouse 10 adopts an optical method to sense the moving direction and displacement without detecting the displacement of the conventional roller indirectly, therefore the optical mouse 10 can prevent the optical sensor 12 from being adhered or interfered by the dust and dirt, such that a user can use the optical mouse 10 to control the cursor accurately.

The optical sensor 12 of the optical mouse 10 senses the image formed by the light refracted or reflected from the light emitting element 11 and projected onto the mouse pad 13 before the optical sensor 12 determines the moving direction and displacement of the optical mouse 10, and thus the material for making the surface of the mouse pad 13 will directly affect the refractive or reflective rate of the light emitted from the light emitting element 11 to the mouse pad 13, and will further affect the image sensed by the optical sensor 12, and the accuracy of detecting the displacement of the optical mouse 10. Therefore, an inappropriate material of the mouse pad 13 will cause an inaccurate movement of the cursor controlled by the optical mouse 10. The shortcomings of using various different materials for a conventional mouse pad 13 are elaborated below:

(1) If the surface of the mouse pad 13 is made of an easily reflective material (such as glass), the refractive or reflective index of a light emitted from the light emitting element 11 to the mouse pad 13 will be increased substantially, so that the optical sensor 12 has an image over-exposure issue due to a light with a too-high brightness and results in an inaccurate determination of the moving direction and displacement based on the image captured by the optical sensor 12, and the user cannot move the cursor accurately.

(2) If the surface of the mouse pad 13 is made of an uneasily reflective material (such as a piece of cloth) or a light transmitting material (such as rubber or silicone), the refractive or reflective index of a light emitted from the light emitting element 11 to the mouse pad 13 will be decreased substantially, so that the optical sensor 12 results in an inaccurate determination of the moving direction and displacement based on the image captured by the optical sensor 12, and the user cannot move the cursor accurately.

It is an important subject for the present invention to provide a novel method for manufacturing a mouse pad capable of enhancing the accuracy of detecting a displacement of an optical mouse, and overcome the inaccurate determination of the moving direction and displacement of the optical mouse on a conventional mouse pad and the incapability of moving the cursor accurately.

### SUMMARY OF THE INVENTION

In view of the shortcomings of the prior art, the inventor of the present invention based on years of experience in the related industry to conduct extensive researches and experiments, and finally developed a manufacturing method of a mouse pad capable of enhancing the precision of detecting a displacement of an optical mouse in accordance with the present invention, in hope of overcoming the shortcomings of the conventional mouse pad that cannot determine the moving direction and displacement of an optical mouse accurately or users cannot move and display a cursor on a display screen of a computer device through the optical mouse accurately.

Therefore, it is a primary objective of the present invention to provide a manufacturing method of a mouse pad capable of enhancing the precision of detecting a displacement of an optical mouse, and the manufacturing method comprises the steps of: mixing silicone and light reflecting particles (such as pearl powder, porcelain bead powder and silver powder, etc) into a mixed material, and putting the mixed material into a mold to form a pad body by hot pressing; coating a transparent coating (such as polyurethane and Teflon, etc) on a surface of the pad body to form a flat smooth layer on the surface of the pad body to produce a mouse pad of the present invention, such that users can move an optical mouse on a smooth layer of the mouse pad smoothly. When the optical mouse is moved, the mouse pad emits a light for detecting a displacement, and a portion of the light is projected into the smooth layer and silicone, such that the brightness of the light is decreased to avoid an over-exposed image sensed by an optical sensor of the optical mouse. In addition, the optical sensor can sense an image of a significant difference due to the reflection or refraction of the portion of the light from each light reflecting particle, so that the optical mouse can determine the moving direction and displacement of the optical mouse accurately and easily from the images. Another objective of the present invention is to provide a manufacturing method of a mouse pad capable of enhancing the precision of detecting a displacement of an optical mouse, wherein the manufacturing method further comprises the step of coating a duller onto the surface of the pad body to corrode the surface of the pad body to form a plurality of irregular corroded lines on the surface of the pad body, and the optical sensor can sense an image of a more significant difference through the reflection or refraction of the portion of the light from each corroded line and light reflecting particle to determine the moving direction and displacement of the optical mouse from the images accurately.

A further objective of the present invention is to provide a manufacturing method of a mouse pad capable of enhancing the precision of detecting a displacement of an optical mouse, wherein after the corrosion process takes place, the manufacturing method further comprises the step of performing a first baking process to the surface of the pad body, such that silicone capillary holes on the surface of the pad body are enlarged for attaching the transparent coating onto the surface of the pad body more easily.

Another objective of the present invention is to provide a manufacturing method of a mouse pad capable of enhancing the precision of detecting a displacement of an optical mouse, wherein the manufacturing method further comprises the step of performing a second baking process to the transparent coating, such that the transparent coating can be dried and attached onto the surface of the pad body more quickly.

### BRIEF DESCRIPTION OF THE DRAWINGS

FIG. 1 is a schematic view of a using status of a conventional mouse pad;

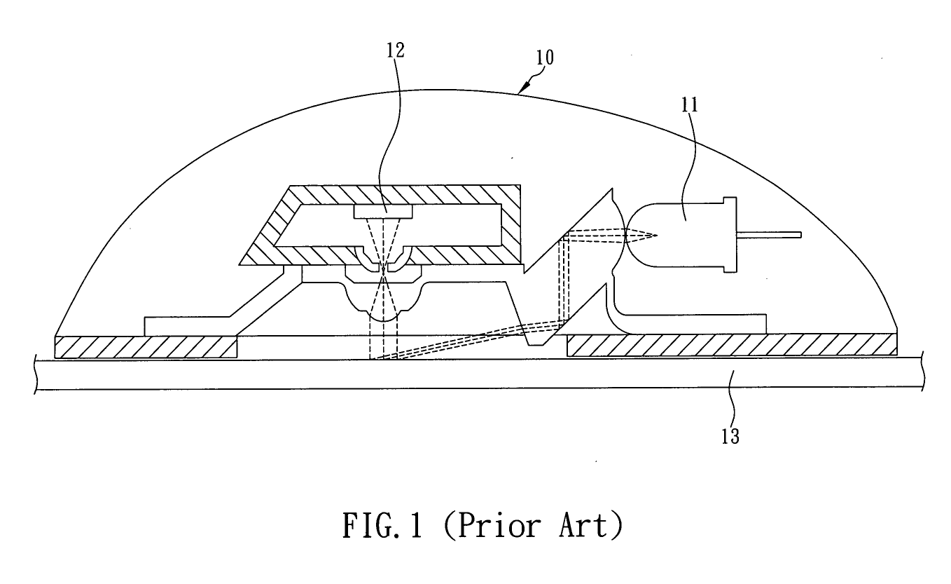

FIG. 2 is a flow chart of a manufacturing method of a mouse pad capable of enhancing the precision of detecting a displacement of an optical mouse in accordance with a preferred embodiment of the present invention;

FIG. 3 is a cross-sectional view of a mouse pad manufactured by a method of the present invention;

FIG. 4 is a schematic view of using the present invention; and

FIG. 5 is a schematic view of an image detected when an optical mouse is moved on a mouse pad of the present invention.

### DETAILED DESCRIPTION OF THE PREFERRED EMBODIMENTS

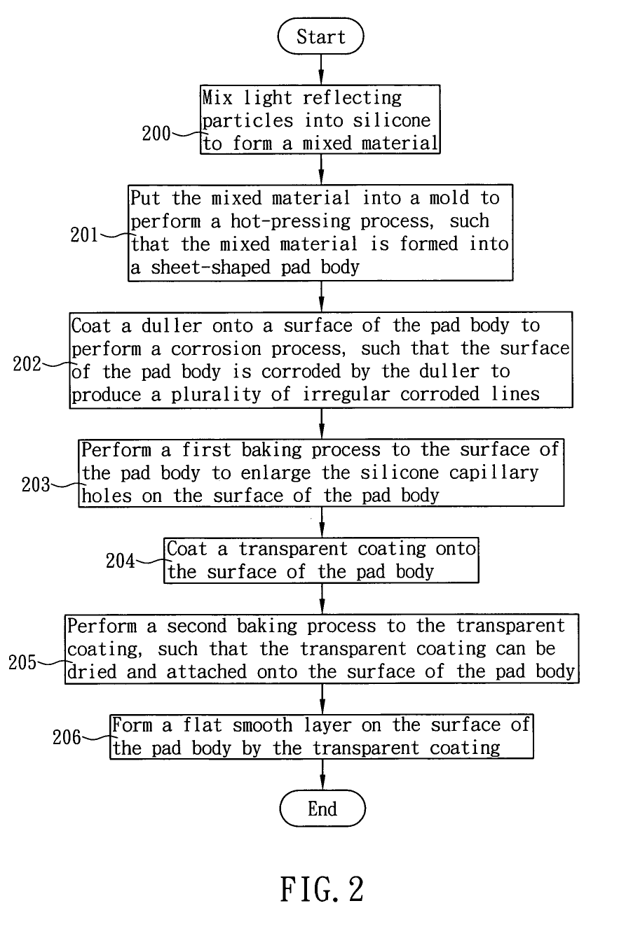

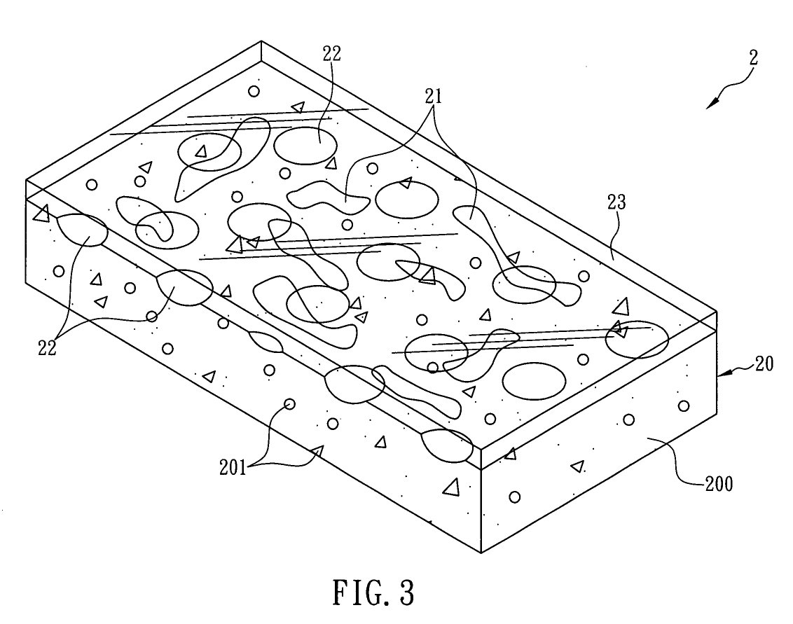

The present invention provides a manufacturing method of a mouse pad capable of enhancing the precision of detecting a displacement of an optical mouse. With reference to FIGS. 2 and 3 for a preferred embodiment of the present invention, the manufacturing method comprises the following steps:

Step (200): mixing light reflecting particles 201 (such as pearl powder, porcelain bead powder and silver powder, etc) into silicone 200 to form a mixed material;

Step (201): putting the mixed material into a mold (not shown in the figure) to perform a hot-pressing process at a temperature from 100 degrees to 250 degrees for a time period from 50 seconds to 250 seconds, such that the mixed material is formed into a sheet-shaped pad body 20;

Step (202): coating a duller onto a surface of the pad body 20 to perform a corrosion process, and the duller is mainly composed of a modified polyoxysilane and toluene, such that the surface of the pad body is corroded by the duller to produce a plurality of irregular corroded lines 21;

Step (203): performing a first baking process to the surface of the pad body at a temperature from 250 degrees to 450 degrees for a time period from one minute to 45 minutes to bake the surface of the pad body intermittently after the corrosion process takes place, so as to enlarge the silicone capillary holes 22 on the surface of the pad body;

Step (204): coating a transparent coating (such as polyurethane and Teflon, etc) onto the surface of the pad body, such that the transparent coating is covered on the surface of the pad body and filled into each corroded line 21 and each capillary hole 22;

Step (205): performing a second baking process to the transparent coating at a temperature from 100 degrees to 200 degrees for at a time period from 50 minutes to 200 minutes, such that the transparent coating can be dried and attached onto the surface of the pad body; and

Step (206) forming a flat smooth layer 23 by the transparent coating on the surface of the pad body to manufacture a mouse pad 2 of the present invention.

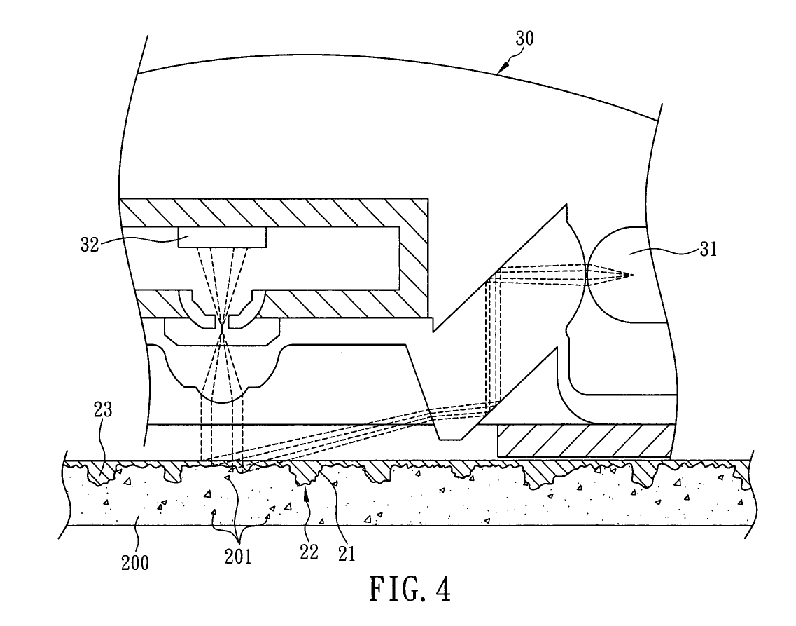

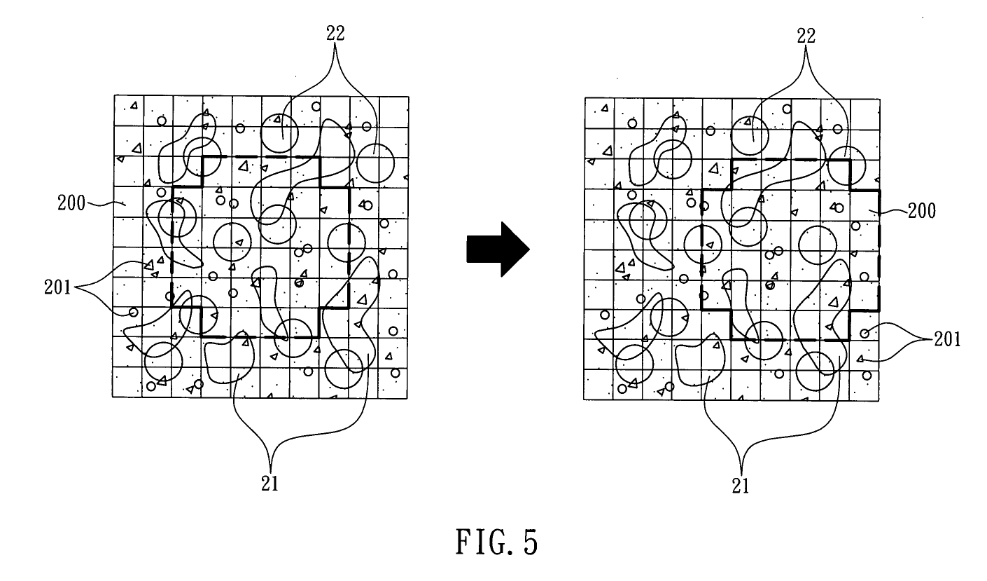

In FIGS. 3 and 4, the smooth layer 23 is laid on a surface of the mouse pad 2, so that a user can move an optical mouse 30 on the smooth layer 23 smoothly. With the transparent smooth layer 23, a light emitting element 31 of the optical mouse 30 can emit a light to the mouse pad 2 for detecting a displacement when the user moves the optical mouse 30 on a pad body 20 of the mouse pad 2 having corroded lines 21 and light reflecting particles 201, and a portion of the light is projected into the smooth layer 23 and silicone 200 to reduce the overall brightness of the light, so as to avoid an over-exposed image sensed by an optical sensor 32 of the optical mouse 30. In addition, the optical sensor 32 can sense an image of a significant difference through the reflection or refraction of the portion of light from each corroded line 21 and each light reflecting particle 201 (as shown in FIG. 5), so that the moving direction and displacement of the optical mouse 30 can be determined easily by the images.

In the preferred embodiment as shown in FIG. 3, the manufacturing method further comprises the step of performing a first baking process to the surface of the pad body to enlarge the silicone capillary holes 22 on the surface of the pad body after the corrosion process takes place, so that when the transparent coating is coated, the transparent coating can be attached onto the surface of the pad body more securely by each capillary hole 22 to prevent the smooth layer 23 from peeling off easily, so as to enhance the using life of the mouse pad 2.

In the preferred embodiment as shown in FIG. 3, the manufacturing method further comprises the step of performing a second baking process to the surface of the pad body to dry and attach the transparent coating onto the surface of the pad body more quickly, after the transparent coating is coated onto the surface of the pad body, so that the production efficiency of manufacturing the mouse pad 2 can be improved.

In the preferred embodiment as shown in FIGS. 2 and 3, the corrosion process as described in Step (202), the first baking process as described in Step (203) or the second baking process as described in Step (205) can be omitted for shortening and simplifying the aforementioned manufacturing procedure of the mouse pad 2 to lower the manufacturing cost. The transparent coating can be attached directly onto the surface of the pad body, and the transparent coating is dried naturally at room temperature to form the smooth layer 23, so that manufacturers need not purchase additional equipments to coat the duller in the corrosion process or the baking equipment for carrying out each baking process, so as to achieve the effect of lowering the manufacturing cost.

In summation of the description above, the mouse pad 2 manufactured by the manufacturing method of the present invention as shown in FIG. 3 mainly allows users to move the optical mouse 30 on the smooth layer 23 of the mouse pad 2 smoothly. If a user moves the optical mouse 30, the optical mouse 30 will emit a light to the mouse pad 2 for detecting a displacement, and a portion of light is projected into the smooth layer 23 and silicone 200 to reduce the overall brightness of the light emitted from the optical mouse 30, so as to avoid an over-exposed image sensed by the optical sensor 32. In addition, the optical sensor 32 senses an image of a significant difference due to the portion of light reflected or refracted from each corroded line 21 and each light reflecting particle 201, so that the optical mouse 30 can determine the moving direction and displacement of the optical mouse 30 according to the images easily and accurately.

While the invention has been described by means of specific embodiments, numerous modifications and variations could be made thereto by those skilled in the art without departing from the scope and spirit of the invention set forth in the claims.

What is claimed is:

1. A manufacturing method of a mouse pad capable of enhancing the precision of detecting a displacement of an optical mouse, comprising the steps of:
mixing a plurality of light reflecting particles in silicone to form a mixed material;
putting the mixed material into a mold to perform a hot-pressing process to shape the mixed material into a sheet-shaped pad body; and
coating a transparent coating on a surface of the pad body to form a flat smooth layer on the surface of the pad body.

2. The manufacturing method of claim 1, further comprising the step of:
coating a duller on the surface of the pad body to perform a corrosion process, such that the surface of the pad body is corroded by the duller to produce a plurality of irregular corroded lines.

3. The manufacturing method of claim 1, further comprising the step of:
performing a first baking process to the surface of the pad body to enlarge a silicone capillary hole on the surface of the pad body, such that the transparent coating can be attached onto the surface of the pad body more easily.

4. The manufacturing method of claim 2, further comprising the step of:
performing a first baking process to the surface of the pad body to enlarge a silicone capillary hole on the surface of the pad body, such that the transparent coating can be attached onto the surface of the pad body more easily.

5. The manufacturing method of claim 3, wherein the first baking process takes place at a temperature from 250 degrees to 450 degrees for a time period of 1 minute to 45 minutes to bake the surface of the pad body intermittently.

6. The manufacturing method of claim 4, wherein the first baking process takes place at a temperature from 250 degrees to 450 degrees for a time period of 1 minute to 45 minutes to bake the surface of the pad body intermittently.

7. The manufacturing method of claim 4, wherein after the transparent coating is coated onto the surface of the pad body, the method further comprises the step of:
performing a second baking process to the transparent coating, for quickly drying and securely attaching the transparent coating onto the surface of the pad body.

8. The manufacturing method of claim 7, wherein the second baking process takes place at a temperature from 100 degrees to 200 degrees for a time period of 50 minutes to 200 minutes.

9. The manufacturing method of claim 8, wherein the hot-pressing process takes place at a temperature from 100 degrees to 250 degrees for a time period of 50 seconds to 250 seconds.
